(19) United States
(12) Patent Application Publication
(10) Pub. No.: US 2004/0130560 A1
(43) Pub. Date: Jul. 8, 2004

(54) Electro-optical device, method of driving electro-optical device, and electronic apparatus

(75) Inventors: Yojiro Matsueda, Chino-shi (JP); Hayato Nakanishi, Toyama-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/694,005

(22) Filed: Oct. 28, 2003

(30) Foreign Application Priority Data
Nov. 1, 2002 (JP) 2002-319677

(51) Int. Cl. G09G 5/10

(52) U.S. Cl. 345/692

(57) ABSTRACT

The invention provides an electro-optical device, a method of driving an electro-optical device, and an electronic apparatus in which flicker can be decreased. When ‘1’, ‘2’, ‘4’, ‘8’, ‘16’, and ‘32’ are assigned to each sub-frame to display half tone of sixty four gray scale levels, a period of one frame is composed of the first to seventh sub-frames SF1 to SF7 designating predetermined light-emitting periods TL1 to TL7, respectively. A sub-frame designating ‘32’ which is the longest light-emitting period, is allocated to the fourth sub-frame SF4 and the seventh sub-frame SF7, and at the same time, the allocated two sub-frames SF4, SF7 are arranged inconsecutively. When the longest ‘32’ is selected based on the gray scale data, both sub-frames SF4, SF7 are selected.

### BACKGROUND OF THE INVENTION

1. Field of Invention

The present invention relates to an electro-optical device, a method of driving an electro-optical device, and an electronic apparatus.

2. Description of Related Art

Related art display devices, such as electro-optical devices, using an organic EL element, can be advantageous. In such electro-optical devices, a digital driving method can be used to control a half tone of an organic EL element. The digital driving method has an advantage in that a pixel circuit can be made to be smaller because it is unnecessary to consider the threshold variation of a driving transistor, composed of a thin film transistor, to drive an organic EL element. One such digital method is a time-divisional gray scale method. The time-divisional gray scale method is a method of attaining a gray scale by repeating a set-reset operation. The set-reset operation is defined by a set step of sending an ON signal through a scanning line to a switching transistor and sending a selection signal to select a conductive state or a non-conductive state of a driving transistor in response to the On signal to the driving transistor, and a reset step of sending an ON signal through the scanning line to the switching transistor and sending to the driving transistor a reset signal, as disclosed in Japanese Unexamined Patent Application Publication No. 2002-175047.

### SUMMARY OF THE INVENTION

However, for example, there are some cases where a plurality of sub-frames in one frame are selected (set), and the light-emitting states are maintained during light-emitting periods of the plurality of sub-frames. On the other hand, there are some cases where a specific sub-frame is selected in one frame, and a light-emitting state is maintained only during the light-emitting period of the sub-frame.

In the former, because light-emitting states are maintained during the predetermined plural light-emitting periods of one frame, the light-emitting cycle is short. Conversely, in the latter, because the light-emitting state is maintained only during one predetermined light-emitting period of one frame, the light-emitting cycle is long. As a result, when the light-emitting state is maintained during the predetermined light-emitting period, there is a problem with generation of flicker. Specifically, when only the longest sub-frame is selected and the image of one frame is formed, a flicker appears since the cycle is long and the light-emitting brightness is high.

Accordingly, the present invention addresses or solves the above and/or other problems, and provides an electro-optical device, a method of driving an electro-optical device, and an electronic apparatus that is capable of decreasing the generation of flicker.

An electro-optical device according to the present invention includes a plurality of pixels that each have an electro-optical element. Brightness of the electro-optical element is set for each of a plurality of sub-frames, which constitute one frame of a period and each have a predetermined period, so that at least two levels of brightness can be set for one frame. The plurality of sub-frames include at least two sub-frames having the same period of length.

According to the electro-optical device, at least two sub-frames having the same period of length are set, and light-emitting period is allocated to the at least two sub-frames so that the light-emitting cycle can be made to be shorter to reduce or prevent the generation of flicker.

In this electro-optical device, the at least two sub-frames have the longest period among the plurality of sub-frames.

Accordingly, since a plurality of sub-frames having the longest period are set, especially when an image is displayed by continuously using the sub-frames having the longest period, it is possible to make the light-emitting cycle shorter, and thus to reduce or prevent the generation of flicker.

In the electro-optical device, a sub-frame having the longest period among the plurality of sub-frames excluding the at least two sub-frames is half as long as the sub-frames having the longest period among the plurality of sub-frames.

According to such a construction, when an image is displayed by continuously using the sub-frames having the half-length of period, it is possible to make the light-emitting cycle shorter, and thus to reduce or prevent the generation of flicker.

In this electro-optical device, the at least two sub-frames are not arranged consecutively in one frame of period.

As a result, since the at least two sub-frames are not arranged adjacent to each other in one frame of period, when an image is displayed by continuously using the sub-frames, it is possible to make the light-emitting cycle shorter, and thus to reduce or prevent the generation of flicker.

An electro-optical device according to the present invention includes a plurality of pixels that each have an electro-optical element. Brightness of the electro-optical element is set for each of a plurality of sub-frames, which constitute one frame of a period and each have a predetermined period, so that at least two levels of brightness can be set for one frame. Lengths of the plurality of sub-frames excluding two sub-frames having the longest period are set in binary load.

According to such a construction, when an image is displayed by continuously using the two sub-frames having the longest period, for example, by arranging the sub-frames not adjacent to each other, and allocating the light-emitting period to the sub-frames, it is possible to make the light-emitting cycle shorter, and thus to reduce or prevent the generation of flicker.

According to this electro-optical device, the two sub-frames having the longest period are not arranged consecutively in one frame of period.

As a result, since the two sub-frames are not arranged adjacent to each other in one frame of period, when an image is displayed by continuously using the sub-frames, it is possible to reduce or prevent the generation of flicker because the light-emitting cycle becomes shorter.

An electro-optical device according to the present invention includes a plurality of pixels that each have an electro-optical element. Brightness of the electro-optical element is set for each of a plurality of sub-frames, which constitute one frame of a period and each have a predetermined period, so that at least two levels of brightness can be set for one frame. A sub-frame having the longest period among n (n denotes a natural number) sub-frames of the plurality of sub-frames excluding two sub-frames having the longest period is set to 2ⁿ⁻¹ times as long as a sub-frame having the shortest period among the n sub-frames, and the brightness for one frame can be set to 2ⁿ⁺¹ levels.

According to this electro-optical device, if the lengths of two sub-frames having the longest period are added to each other, the sum is 2ⁿ times as long as a sub-frame having the shortest period among the n sub-frames. Thus, when an image is displayed by continuously using the two sub-frames having the longest period, for example, by arranging the sub-frames not adjacent to each other and allocating the light-emitting period to the sub-frames, it is possible to make the light-emitting cycle shorter, and thus to reduce or prevent the generation of flicker.

According to this electro-optical device, the two sub-frames having the longest period are not set consecutively in one frame of period.

As a result, because the two sub-frames having the longest period are not arranged adjacent to each other in one frame of period, when an image is displayed by continuously using the sub-frames, it is possible to reduce or prevent the generation of flicker because the light-emitting cycle becomes shorter.

An electro-optical device according to the present invention includes a plurality of pixels that each have an electro-optical element. Brightness of the electro-optical element is set for each of a plurality of sub-frames, which constitute one frame of a period and each have a predetermined period, so that at least two levels of brightness can be set for one frame. The sum of two sub-frames having the longest period among the plurality of sub-frames is set to 2ⁿ (n denotes a natural number) times as long as a sub-frame having the shortest period among the plurality of sub-frames and the brightness for one frame can be set to 2ⁿ⁺¹ levels.

According to this electro-optical device, if the lengths of the two sub-frames having the longest period are added to each other, the sum is 2ⁿ times as long as a sub-frame having the shortest period among the n sub-frames. Thus, when image is displayed by continuously using the two sub-frames, for example, by arranging the sub-frames not adjacent to each other and allocating the light-emitting period to the sub-frames, it is possible to make the light-emitting cycle shorter, and thus to reduce or prevent the generation of flicker.

According to this electro-optical device, the two sub-frames are not arranged consecutively in one frame of period.

As a result, since the two sub-frames are not arranged adjacent to each other in one frame of a period, when an image is displayed by continuously using the sub-frames, it is possible to reduce or prevent the generation of flicker because the light-emitting cycle becomes shorter.

An electro-optical device according to the present invention includes a plurality of pixels that each have an electro-optical element. Brightness of the electro-optical element is set for each of a plurality of sub-frames, which constitute one frame of a period and each have a predetermined period, so that at least 2ⁿ (n denotes a natural number) levels of brightness can be set for one frame. The number of the plurality of sub-frames is n+1 or more.

According to this electro-optical device, by using at least two sub-frames among the (n+1) sub-frames or more, the light-emitting period is allocated to the at least two sub-frames, and it is possible to make the light-emitting cycle shorter, and thus to reduce or prevent the generation of flicker.

According to this electro-optical device, a sub-frame having the longest period among the plurality of sub-frames is 2ⁿ⁻¹ times as long as a sub-frame having the shortest period.

According to this electro-optical device, if the lengths of the two sub-frames having the longest period are added to each other, the sum is 2ⁿ⁻¹ times as long as a sub-frame having the shortest period among the n sub-frames. Thus, by using the sub-frames having the longest period and other sub-frames, none of which is arranged adjacent to each other, and allocating the light-emitting period to the sub-frames, it is possible to make the light-emitting cycle shorter, and thus to reduce or prevent the generation of flicker.

An electro-optical device according to the present invention is capable of setting at least two levels of brightness for one frame. The electro-optical device includes electro-optical elements that are switched to an ON state or an OFF state based on gray scale data for each of a plurality of sub-frames, which constitute one frame of period and each have a predetermined period, and at least two sub-frames of the plurality of sub-frames are always concurrently switched to an ON state or an OFF state.

According to this electro-optical device, by allocating the light-emitting period to the at least two sub-frames which are always concurrently switched to an ON state or an OFF state, it is possible to make the light-emitting cycle shorter, and thus to reduce or prevent the generation of flicker.

According to this electro-optical device, at least two sub-frames have the same of period length.

As a result, the light-emitting period based on each of the at least two sub-frames always concurrently put into a set state or a non-set state is the same.

According to this electro-optical device, the at least two sub-frames are not arranged consecutively in the frame of a period.

As a result, since the at least two sub-frames are not arranged adjacent to each other in one frame of a period, when an image is displayed by continuously using the sub-frames, it is possible to reduce or prevent the generation of flicker because the light-emitting cycle becomes shorter.

According to this electro-optical device, the plurality of sub-frames, which are set for a series of pixels of the plurality of pixels, the series of pixels being connected to one scanning line, start and end substantially simultaneously.

Accordingly, for each sub-frame, it is controlled to emit light and distinguish light sequentially for each pixel on the respective scanning lines.

According to this electro-optical device, the plurality of sub-frames, which are set for a series of pixels among the plurality of pixels, the series of pixels being connected to at least two scanning lines, end substantially simultaneously.

As a result, for each sub-frame, every pixel is controlled to emit light and to distinguish light simultaneously.

This electro-optical device includes pixel circuits, each of which includes a first transistor put into a conductive state when the scanning line thereof is selected, a capacitor element holding a data signal supplied through the first transistor, a second transistor switched to an ON state or an OFF state based on the data signal held in the capacitor element, and an electronic element to which a driving current is supplied based on the ON state of the second transistor.

Accordingly, when the connected scanning line is selected, the first transistor is put into the conductive state and supplies a data signal to the capacitor element. The second transistor is switched to an ON state or an OFF state based on the data signal held in the capacitor element and supplies driving current to the electronic element based on the ON state.

According to this electro-optical device, the electronic element is a current-driven element.

Accordingly, driving current is supplied to the current-driven element based on the ON state of the second transistor.

According to this electro-optical device, the current-driven element is an EL element.

Accordingly, driving current is supplied to the EL element based on the ON state of the second transistor, and the EL element emits light.

According to this electro-optical device, the EL element has a light-emitting layer formed of an organic material.

Accordingly, driving current is supplied to the organic EL element based on the ON state of the second transistor, and the organic EL element emits light.

A method of driving an electro-optical device according to the present invention drives an electro-optical device that includes a plurality of pixels that each have an electro-optical element. Brightness of the electro-optical element is set for each of a plurality of sub-frames, which constitute one frame of a period and each have a predetermined period, so that at least two levels of brightness can be set for one frame, the plurality of sub-frame include at least two sub-frames having the same period of length, and when the at least two sub-frames are set, the at least two sub-frames are arranged so as not to be adjacent to each other.

According to this driving method, the at least two sub-frames having the same period of length are set and the light-emitting period is allocated to the at least two sub-frames while the two sub-frames are arranged so as not to be adjacent to each other, so that the light-emitting cycle becomes shorter, and thus the generation of flicker can be reduced or prevented.

A method of driving an electro-optical device according to the present invention drives an electro-optical device that includes a plurality of pixels that each have an electro-optical elements. Brightness of the electro-optical element is set for each of a plurality of sub-frames, which constitute one frame of a period and each have a predetermined period, so that at least two levels of brightness can be set for one frame, lengths of the plurality of sub-frames excluding two sub-frames having the longest period are set in binary load, and when the two sub-frames are set, the two sub-frames are arranged so as not to be adjacent to each other.

According to this driving method, when an image is displayed by using the two sub-frames having the longest period, for example, by arranging the two sub-frames so as not to be adjacent to each other and allocating the light-emitting period to the two sub-frames, it is possible to make the light-emitting cycle shorter, and thus to reduce or prevent the generation of flicker.

A method of driving an electro-optical device according to the present invention drives an electro-optical device that includes a plurality of pixels that each have an electro-optical element. Brightness of the electro-optical elements is set for each of a plurality of sub-frames, which constitute one frame of a period and each have a predetermined period, so that at least two levels of brightness can be set for one frame. A sub-frame having the longest period among n (n denotes a natural number) sub-frames of the plurality of sub-frames excluding two sub-frames having the longest period is set to 2ⁿ⁻¹ times as long as a sub-frame having the shortest period among the n sub-frames, and when the two sub-frames are set, the two sub-frames are arranged so as not to be adjacent to each other, and brightness for one frame can be set to 2ⁿ⁺¹ levels.

According to this driving method, if the lengths of the two sub-frames having the longest period are added to each other, the sum is 2ⁿ times as long as a sub-frame having the shortest period among the n sub-frames. Furthermore, when an image is displayed by continuously using the two sub-frames having the longest period, for example, by arranging the two sub-frames so as not to be adjacent to each other and allocating the light-emitting period to the two sub-frames, it is possible to make the light-emitting cycle shorter, and thus to reduce or prevent the generation of flicker.

A method of driving an electro-optical device according to the present invention drives an electro-optical device that includes a plurality of pixels that each have an electro-optical element. Brightness of the electro-optical elements is set for each of a plurality of sub-frames, which constitute one frame of a period and each have a predetermined period, so that at least two levels of brightness can be set for one frame. The sum of two sub-frames having the longest period among the plurality of sub-frames is set 2ⁿ (n denotes a natural number) times as long as a sub-frame having the shortest period among the plurality of sub-frames, and when the two sub-frames are set, the two sub-frames are arranged so as not to be adjacent to each other, and brightness for the one frame can be set to 2ⁿ⁺¹ levels.

According to this driving method, if the lengths of the two sub-frames having the longest period are added to each other, the sum becomes 2ⁿ times as long as a sub-frame having the shortest period among the n sub-frames. Thus, when an image is displayed by using the two sub-frames, for example, by arranging the sub-frames so as not to be adjacent to each other and allocating the light-emitting period to the two sub-frames, it is possible to make the light-emitting cycle shorter, and thus to reduce or prevent the generation of flicker.

A method of driving an electro-optical device according to the present invention drives an electro-optical device that comprises a plurality of pixels that each have an electro-optical element. Brightness of the electro-optical element is set for each of a plurality of sub-frames, which constitute one frame of a period and each have a predetermined period, so that at least 2ⁿ (n denotes a natural number) levels of brightness can be set for one frame. The number of the plurality of sub-frames is n+1 or more, predetermined two sub-frames thereof are always concurrently put into a set state or a non-set state, and when in the set state, the two sub-frames are arranged so as not to be adjacent to each other, and brightness for one frame can be set to 2ⁿ⁺¹ levels.

According to this driving method, by using at least two sub-frames among the (n+1) sub-frames or more, allocating the light-emitting period to the two sub-frames, and arranging the two sub-frames so as not to be adjacent to each other, it is possible to make the light-emitting cycle shorter, and thus to reduce or prevent the generation of flicker.

According to this driving method, the plurality of sub-frames, which are set for a series of pixels among the plurality of pixels, the series of pixels being connected to one scanning line, start and end substantially simultaneously.

As a result, for each sub-frame, it is controlled to emit light sequentially and to distinguish light sequentially for each pixel on each scanning line.

According to this driving method, the plurality of sub-frames, which are set for a series of pixels among the plurality of pixels, the series of pixels being connected to at least two scanning lines, end substantially simultaneously.

According to this driving method, for each sub-frame, every pixel is controlled to emit light and distinguish light simultaneously.

In this method of driving an electro-optical device, the electro-optical device includes pixel circuits, each of which includes a first transistor put into a conductive state when the scanning line thereof is selected, a capacitor element holding a data signal supplied through the first transistor, a second transistor switched to an ON state or an OFF state based on the data signal held in the capacitor element, and an electronic element to which a driving current is supplied based on the ON state of the second transistor.

According to this driving method, when a scanning line is selected, the first transistor is put into a conductive state and supplies a data signal to the capacitor element. The second transistor is switched to an ON or an OFF based on the data signal held in the capacitor element and supplies driving current to the electronic element based on the ON operation.

An electronic apparatus according to the present invention is equipped with any of the electro-optical devices described above.

Accordingly, flicker is reduced or eliminated in the electronic apparatus.

### BRIEF DESCRIPTION OF THE DRAWINGS

FIG. 1 is a schematic circuit diagram illustrating a circuit configuration of an organic EL display according to an exemplary embodiment;

FIG. 2 is a schematic circuit diagram illustrating an inner circuit configuration of a pixel circuit;

FIG. 3 is a time chart explaining a time-divisional gray scale method according to the present exemplary embodiment;

FIG. 4 is a schematic perspective view of a mobile type personal computer equipped with an organic EL display according to the present exemplary embodiment;

FIG. 5 is a schematic perspective view of a cellular phone equipped with an organic EL display according to the present exemplary embodiment;

FIG. 6 is a time chart explaining a simultaneous turning-on manner according to the present invention;

FIG. 7 is a time chart explaining a simultaneous turning-on manner according to the related art;

FIG. 8 is a time chart explaining a sequential turning-on and simultaneous turning off manner according to the related art.

### DETAILED DESCRIPTION OF PREFERRED EMBODIMENTS

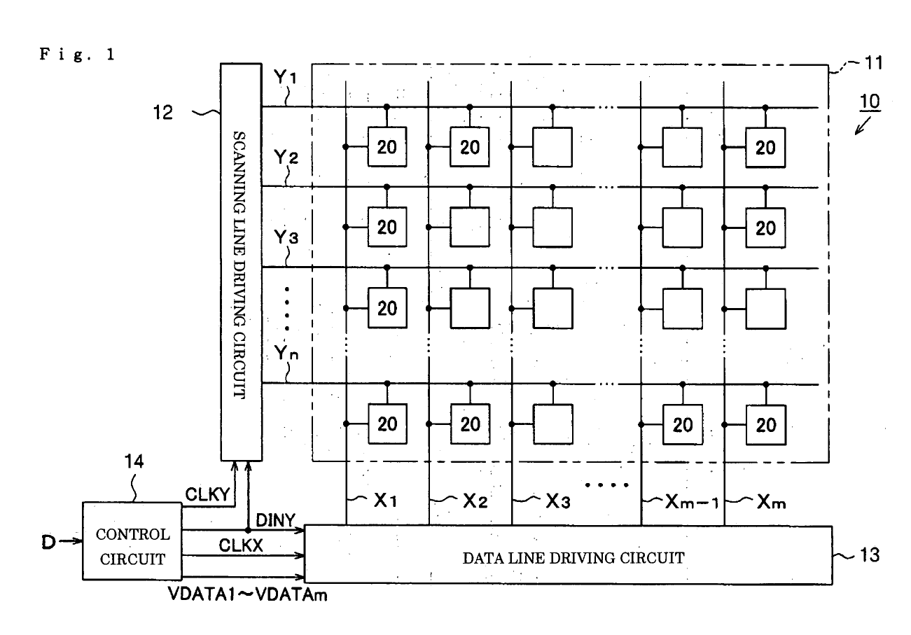

An exemplary embodiment of the present invention is described below with reference to FIGS. 1 to 3.

FIG. 1 is a schematic circuit diagram illustrating an electrical configuration of an organic EL display 10 as an electro-optical device. The organic EL display 10 includes a display panel part 11, a scanning line driving circuit 12, a data line driving circuit 13, and a control circuit 14.

The display panel part 11 and each of circuits 12 to 14 of the organic EL display 10 may be composed of an individual electronic component. For example, each of the circuits 12 to 14 may be composed of one chip of semiconductor integrated circuit device. Further, all or some of the display panel part 11 and each of the circuits 12, 13 may be integrally constructed as an electronic component. For example, to the display panel part 11, the data line driving circuit 13 and the scanning line driving circuit 12 may be integrally formed. All or some of the circuits 12 to 14 may be composed of a programmable IC chip, and the function thereof may be realized in software by program recorded in the IC chip.

The display panel part 11, as shown in FIG. 1, includes a plurality of pixel circuits 20 as electronic circuits that are arranged in a matrix. That is, each of the pixel circuits 20 is disposed at each intersection of a plurality of data lines X1 to Xm (m denotes an integer) extending in the column direction and a plurality of scanning lines Y1 to Yn (n denotes an integer) extending in the row direction. Furthermore, the respective pixel circuits 20 are connected between the corresponding data lines X1 to Xm and scanning lines Y1 to Yn, thereby being arranged in a matrix. Each of the pixel circuits 20 includes an organic EL element 21 whose light-emitting layer is formed of an organic material as an electronic element, a current-driven element or an electro-optical device. A transistor, which is formed in each of the pixel circuits 20 and is described below, is usually composed of a thin film transistor.

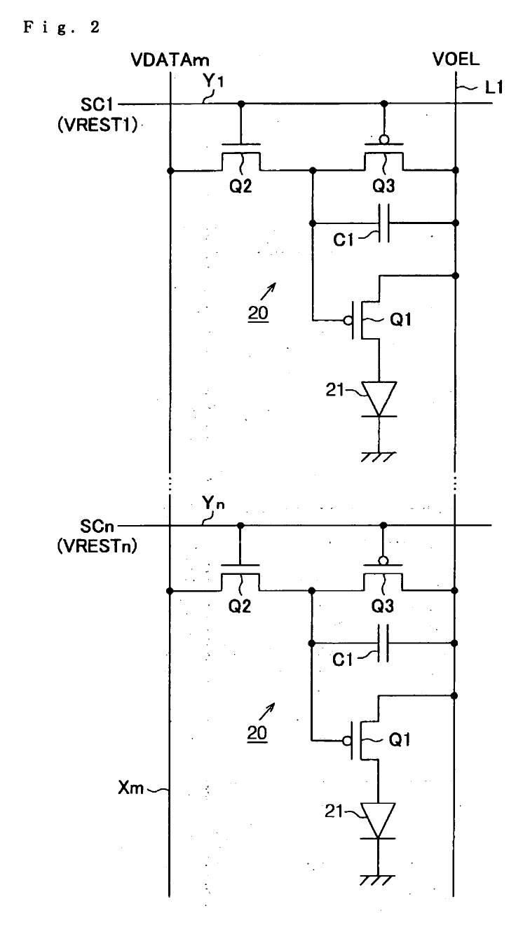

FIG. 2 is a schematic circuit diagram to illustrate an inner circuit configuration of the pixel circuit 20. For the convenience of illustration, a pixel circuit 20, which is disposed at the intersection of an m-th data line Xm and an n-th scanning line Yn and connected to both the data line Xm and the scanning line Yn, is described.

The pixel circuit 20 includes a driving transistor Q1 as a second transistor, a switching transistor Q2 as a first transistor, a reset transistor Q3, and a storage capacitor C1 as a capacitor element. The switching transistor Q2 is composed of an N-channel FET. The driving transistor Q1 and the reset transistor Q3 are composed of a P-channel FET.

The driving transistor Q1 has a drain connected to an anode of the organic EL element and a source connected to a source line L1 supplied with a source voltage VOEL. The storage capacitor C1 is connected between a gate of the driving transistor Q1 and the source line L1. Further, the gate of the driving transistor Q1 is connected to the data line Xm via the switching transistor Q2. A gate of the switching transistor Q2 is connected to the scanning line Yn.

The reset transistor Q3 is connected parallel to the storage capacitor C1. A gate of the reset transistor Q3 is connected to the scanning line Yn.

In the pixel circuit 20 having such structure, when a scanning signal SCn is output from the scanning line driving circuit 12 to the scanning line Yn, the switching transistor Q2 is in an ON state. When the switching transistor Q2 is put into the ON state, data VDATA which is output from the data line driving circuit 13 to the data line Xm is stored in the storage capacitor. The data VDATA is a data causing the driving transistor Q1 be in an ON state or an OFF state. Even when scanning signal SCn disappears and the switching transistor Q2 is put into an OFF state, the storage capacitor C1 storing the data VDATA may hold the previously stored data VDATA.

Then, the driving transistor Q1 is switched to an ON state or an OFF state based on the contents of the stored data VDATA. When the driving transistor Q1 is in the ON state, driving current is supplied to the organic EL element 21 and the organic EL element emits light.

Conversely, when the driving transistor Q1 is in the OFF state, driving current is not supplied to the organic EL element 21 and the organic EL element stops emitting light.

Next, when a reset signal VSRESTn having a minus potential is output from the scanning line driving circuit 12 to the scanning line Yn, the reset transistor Q3 is switched from an OFF state to an ON state. When the reset transistor Q3 is in the ON state, a source voltage VOEL is supplied from the source line L1 through the reset transistor Q3 to the storage capacitor C1 and the precedent data VOEL is eliminated, and the gate of the driving transistor Q1 becomes a potential of the source voltage VOEL. That is, the storage capacitor C1 is reset.

When the storage capacitor C1 is reset, the driving transistor Q1 is put into an OFF state and the organic EL element 21, which is emitting light based on the precedent data VDATA, stops emitting light and waits for the light-emitting operation which will be executed subsequently. Namely, the light-emitting period of an organic EL element 21 of each pixel circuit 20 is the period between the output of scanning signals SC1 to SCn and the output of reset signals VREST1 to VRESTn.

The scanning line driving circuit 12 is a circuit to select one of the plurality of scanning lines Y1 to Yn, that is, output scanning signal, and drive a group of the pixel circuits 20 connected to the selected scanning line. The scanning line driving circuit 12 outputs the scanning signals SC1 to SCn to each of the scanning lines Y1 to Yn at a predetermined timing based on various signals from the control circuit 14.

The data line driving circuit 13 generates data VDATA1 to VDATAm for of the respective data lines X1 to Xm and outputs the data VDATA1 to VDATAm to the corresponding data lines X1 to Xm. The data line driving circuit 13 outputs the data VDATA1 to VDATAm synchronized with the scanning signals SC1 to SCn. That is, when the scanning line driving circuit 12 outputs a scanning signal to one scanning line, the data line driving circuit 13 outputs the data VDATA1 to VDATAm with respect to the respective pixel circuits on the selected scanning line.

The control circuit 14 receives image data D from an external device which is not shown, and generates data VDATA1 to VDATAm for the respective sub-frames for time-divisional gray scale based on the image data D. Also, the control circuit 14 generates a start pulse signal DINY and clock signals CLKY, CLKX. The start pulse signal DINY is a signal rising to H level for only a constant period in order to execute selection of the first scanning line in each sub-frame of one frame, and is output to the scanning line driving circuit 12 and the data line driving circuit 13. The clock signal CLKY is output to the scanning line driving circuit 12 to decide timings of sequentially outputting the scanning signals SC1 to SCn which are generated by the scanning line driving circuit 12 so as to select a scanning line sequentially.

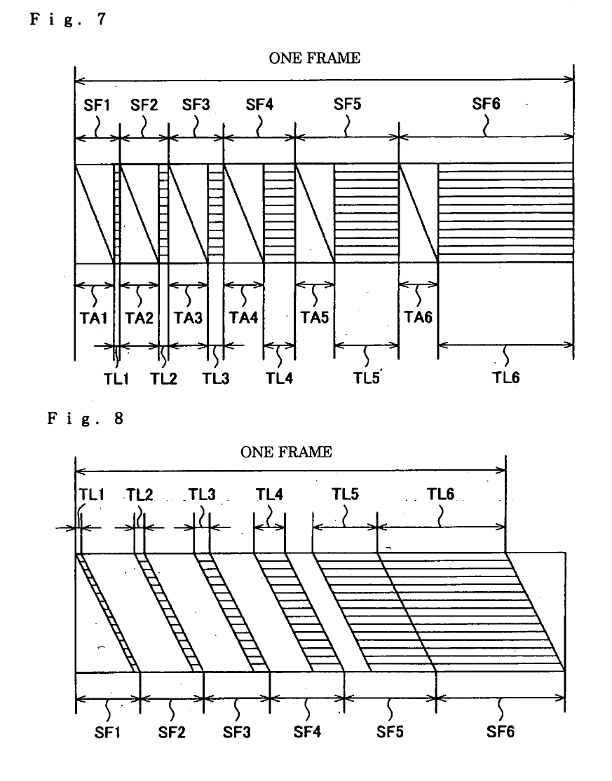

The organic EL display 10 is a display capable of displaying a halftone in sixty-four gray scale levels by time-divisional gray scale method. Thus, in the organic EL display 10, one frame is composed of a plurality of sub-frames to realize sixty-four gray scale levels. More particularly, in the present exemplary embodiment, as shown in FIG. 3, one frame is divided into seven sub-frames SF1 to SF7. That is, although in the case of sixty-four gray scale levels, one frame is generally composed of six sub-frames having period lengths of ‘1’, ‘2’, ‘4’, ‘8’, ‘16’, and the top ‘32’ bits, respectively (see FIGS. 7 and 8), in the present exemplary embodiment, one frame is composed of seven sub-frames SF1 to SF7 including an additional one.

The sub-frames SF1 to SF7 have light-emitting periods TL1 to TL7, respectively, where 16 TL1=8 TL2=4 TL3=TL4=2 TL5=TL6=TL7. That is, the respective light-emitting periods TL1 to TJ7 are TL1:TL2:TL3:TL4:TL5:TL6:TL7=1:2:4:16:8:16:16.

Namely, in the related art, as shown in FIGS. 7 and 8, the length of the light-emitting period, i.e., TL6, of the sixth sub-frame SF6 which designates the longest light-emitting period among the six sub-frames SF1 to SF6 is set to ‘32’. However, in the organic EL display 10 of the present exemplary embodiment, as shown in FIG. 3, the ‘32’ is divided by two and each ‘16’ is allocated to two sub-frames (the fourth sub-frame SF4 and the seventh sub-frame SF7) to form one frame constituted of the seven sub-frames SF1 to SF7.

Therefore, while in the related art, the gray scales are controlled by a sub-frame having ‘32’, the fourth sub-frame SF4 and the seventh sub-frame SF7 are responsible for it in the preset exemplary embodiment. Thus, the fourth sub-frame SF4 and the seventh sub-frame SF7 are controlled to have always the same brightness per a unit of period without being controlled independently. In a binary driving method where each sub-frame takes either a non-light-emitting state or a light-emitting state, or either an ON state or an OFF state, when the fourth sub-frame SF4 is either in a light-emitting state or an ON state, the seventh sub-frame SF7 is always concurrently either in the light-emitting state or the ON state, and when the fourth sub-frame SF4 is either in a non-light-emitting state or an OFF state, the seventh sub-frame SF7 is always concurrently either in the non-light-emitting state or the OFF state.

In the case of obtaining brightness gray scale of ‘32’, the organic EL element is caused to emit light in the fourth sub-frame SF4 and the seventh sub-frame SF7. Accordingly, the organic EL element turns off light in the first to the third, the fifth, the sixth sub-frames SF1 to SF3, SF5, and SF6, so that the brightness gray scale of ‘32’ can be obtained.

In the case of obtaining a brightness gray scale of ‘44’, the organic EL element is caused to emit light in the third, the fourth, the fifth, and the seventh sub-frames SF3, SF4, SF5, and SF7. Accordingly, the organic EL element stops emitting light in the first, the second, and the sixth sub-frames SF1, SF2, and SF6, and thus the brightness gray scale of ‘44’ can be obtained.

In this manner, in the time-divisional gray scale method, in each sub-frame constituting one frame, it is necessary to drive sequentially the respective pixel circuits on each of the scanning lines Y1 to Yn. As a result, to display image of one frame, the scanning line driving circuit 12 sequentially generates the scanning signals SC1 to SCn to sequentially select each of the scanning lines Y1 to Yn in of the respective sub-frames SF1 to SF7. Further, the scanning line driving circuit 12 outputs the scanning signals SC1 to SCn corresponding to the scanning lines Y1 to Yn, and after a predetermined period (light emitting period) has passed, outputs the reset signals VREST1 to VRESTn to the corresponding scanning lines Y1 to Yn. Namely, in the sub-frames SF1 to SF7 the organic EL element is allowed to emit light for only the corresponding light-emitting periods TL1 to TL7.

Further, the control circuit 14 generates data VDATA1 to VDATAm for the first to the seventh sub-frames SF1 to SF7 based on the image data D. Then, to display the image data D of one frame on the organic EL display 10, the control circuit 14 displays one image in sixty-four gray scale levels by dividing one frame into seven sub-frames SF1 to SF7 and using the seven sub-frames.

That is, for the image data D as the gray scale data of one frame, the control circuit 14 causes the data line driving circuit 13 to generate data VDATA1 to VDATAm, which are supplied to each of the pixel circuits 20 on each of the scanning line Y1 to Yn for the first to the seventh sub-frames SF1 to SF7. At this time, the control circuit 14 writes data VDATA1 to VDATAm to display a gray scale of ‘1’ in the first sub-frame SF1, writes data VDATA1 to VDATAm to display a gray scale of ‘2’ in the second sub-frame SF2, and writes data VDATA1 to VDATAm to display a gray scale of ‘4’ in the third sub-frame SF3, respectively. In addition, the control circuit 14 writes data VDATA1 to VDATAm to display a gray scale of ‘8’ in the fifth sub-frame SF5, and writes data VDATA1 to VDATAm to display a gray scale of ‘16’ in the sixth sub-frame SF6.

Furthermore, the control circuit 14 allocates data VDATA1 to VDATAm to display a gray scale of ‘32’ to the fourth sub-frame SF4 and the seventh sub-frame SF7. In other words, without preparing a single sub-frame to display the gray scale of ‘32’, the ‘32’ is allocated to the fourth sub-frame SF4 and the seventh sub-frame SF7 and data VDATA1 to VDATAm to display the gray scale of ‘32’ is written in the fourth sub-frame SF4 and the seventh sub-frame SF7. That is, the control circuit 14 allows to display the gray scale of ‘32’ by using the fourth sub-frame SF4 and the seventh sub-frame SF7 each designating the gray scale of ‘16’.

Further, the scanning line driving circuit 12 generates reset signals VREST1 to VRESTn for the scanning lines Y1 to Yn, for each of the sub-frames SF1 to SF7, based on the clock signal CLKY. The scanning line driving circuit 12 outputs the reset signals VREST1 to VRESTn, respectively, for the first sub-frame SF1 after TL1 period has passed the scanning signals SC1 to SCn were output. For the second sub-frame SF2, the third sub-frame SF3, the fourth sub-frame SF4, the fifth sub-frame SF5, the sixth sub-frame SF6, and the seventh sub-frame SF7, the reset signals VREST1 to VRESTn are output after TL2 (=2×TL1) has passed, TL3 (=4×TL1) has passed, TL4 (=16×TL1) has passed, TL5 (=8×TL1) has passed, TL6 (=16×TL1) has passed, and TL7 (=16×TL1) has passed since the scanning signals SC1 to SCn were output, respectively.

The clock signal CLKX is a signal synchronized with the clock signal CLKY, and is output to the data line driving circuit 13. The clock signal CLKX is a signal to decide a timing to output data VDATA1 to VDATAm through each of data lines X1 to Xm to each of the pixel circuits 20 on the selected scanning line, whenever the scanning lines Y1 to Yn are selected in response to each of the scanning signals SC1 to SCn, for each of the sub-frames SF1 to SF6.

The operation of the above-described organic EL display 10 is explained below.

The control circuit 14, for image data D of one frame, makes the data line driving circuit 13 generate data VDATA1 to VDATAm which are to be supplied to the respective pixel circuits 20 on each of scanning lines Y1 to Yn for the first to seventh sub-frames SF1 to SF7. In addition, the control circuit 14 outputs a start pulse signal DNY and clock signals CLKX, CLKY to the scanning line driving circuit 12 and the data line driving circuit 13.

In response to the start pulse signal DINY from the control circuit 14, the scanning line driving circuit 12 sequentially outputs the scanning signals SC1 to SCn to each of scanning lines Y1 to Yn for the first sub-frame SF1. In addition, the scanning line driving circuit 12 outputs the reset signals VREST1 to VRESTn after TL1 has passed since it outputs the scanning signals SC1 to SCn.

On the other hand, whenever each of the scanning lines Y1 to Yn is selected, the data line driving circuit 13 outputs sequentially data VDATA1 to VDATAm of the first sub-frame SF1 to each of the pixel circuits 20 on the selected scanning line. Thus, each of the pixel circuits 20 on the selected scanning line is operated (turns on light or turns off light) based on the data VDATA1 to VDATAm. Further, each of the pixel circuits 20 turns off light in response to the reset signals VREST1 to VRESTn which are supplied after TL1 period has passed.

When supply of data VDATA1 to VDATAm to each of the pixel circuits 20 on the last scanning line Yn for the first sub-frame SF1 is completed, the scanning line driving circuit 12 inputs the start pulse signal DINY from the control circuit 14. The scanning line driving circuit 12, in response to the start pulse signal DINY, sequentially outputs the scanning signals SC1 to SCn and sequentially selects the corresponding scanning lines Y1 to Yn for the second sub-frame SF2. Also, the scanning line driving circuit 12 outputs the reset signals VREST1 to VRESTn after TL2 (=2×TL1) period has passed since the scanning signals SC1 to SCn were output.

On the other hand, similarly to the as above description, the data line driving circuit 13 sequentially outputs the data VDATA1 to VDATAm to each of the pixel circuits 20 on the selected scanning line for the second sub-frame SF2. Then, each of the pixel circuits 20 on the selected scanning line is operated (turns on light or turns off light) based on the data VDATA1 to VDATAm as mentioned above, and turns off light in response to the reset signals VREST1 to VRESTn which are supplied after TL2 period has passed.

Thereafter, the same operation is repeated for the third to seventh sub-frames SF3 to SF7 and thus an image of one frame is displayed. When display of one frame of image is completed, the image display operation is similarly carried out for the subsequent one frame.

Features of the organic EL display 10 having the above-mentioned structure are described below.

(1) In the present exemplary embodiment, when the half tone of sixty-four gray scale levels is displayed according to time-divisional gray scale, ‘32’, which is the longest period in displaying sixty four gray scales as ‘1’, ‘2’, ‘4’, ‘8’, ‘16’, and ‘32’, is evenly allocated to two sub-frames, the fourth sub-frame SF4 and the seventh sub-frame SF7, instead of being displayed in one sub-frame. That is, when the number of the sub-frames becomes seven by adding one, half of the longest period ‘32’, i.e., ‘16’ is assigned to the additional one sub-frame. In addition, the allocated two sub-frames are assigned to the fourth sub-frame SF4 and the seventh sub-frame SF7 which are separated from each other.

Accordingly, for example, in displaying images which require to be continuously represented by ‘32’ for a plurality of frames, turning-on operation is carried out for the two periods of the fourth sub-frame SF4 and the seventh sub-frame SF7 in one frame. As a result, compared with the case that such images are represented by one sub-frame, the light-emitting cycle becomes short by half so that flicker can be reduced or prevented.

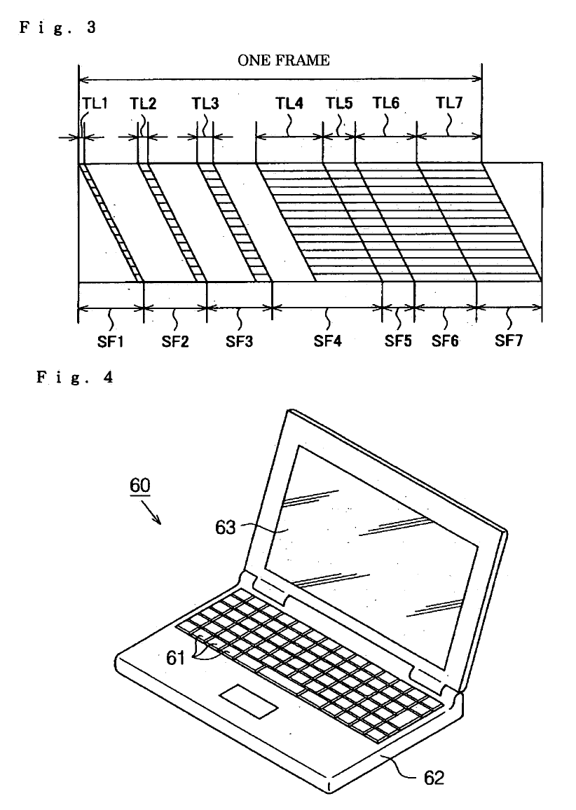

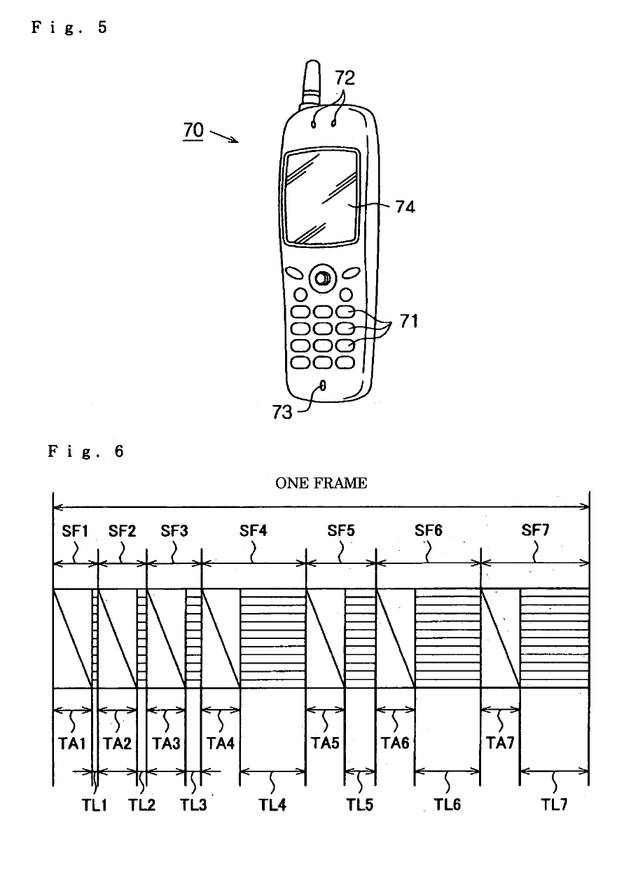

Application to an electronic apparatus of the organic EL display 10 described above as an electro-optical device is described below with reference to FIGS. 4 and 5. The organic EL display 10 can be applied to various electronic apparatus, such as a mobile type personal computer, a cellular phone, a digital camera, and the like, for example.

FIG. 4 is a perspective view illustrating a configuration of a mobile type personal computer. In FIG. 4, a personal computer 60 includes a main body part 62 having a keyboard 61, and a display unit 63 using the organic EL display 10. In this case, the display unit 63 using the organic EL display 10 is also capable of having the same effect as the exemplary embodiment described above. As a result, the personal computer 60 is able to realize an image with little flicker.

FIG. 5 is a perspective view illustrating a configuration of a cellular phone. In FIG. 5, the cellular phone 70 includes a plurality of operating buttons 71, an earpiece 72, a mouthpiece 73, and a display unit 74 using the organic EL display 10. In this case, the display unit 73 using the organic EL display 10 is also capable of having the same effect as the exemplary embodiment described above. As a result, the cellular phone 70 is able to realize an image with little flicker.

The present invention is not limited to the exemplary embodiments described above, and may be modified as described below, for example.

In the above-described exemplary embodiment, an organic EL element 21 is used as an electronic element or a current-driven element of a pixel circuit. However, an inorganic EL element may be used, for example. Namely, the present invention may be applied to an inorganic EL display having an inorganic EL element.

Although in the organic EL display 10 of the above-described exemplary embodiment half tone is controlled by sequential turning-on and simultaneous turning-off operations, which is a kind of time-divisional gray scale method, it is possible to employ simultaneous turning-on operations. For example, as shown in FIG. 6, when sixty-four gray scale levels are displayed, ‘32’, which is the longest period in displaying sixty-four gray scale levels as ‘1’, ‘2’, ‘4’, ‘8’, ‘16’, and ‘32’, is allocated to two sub-frames, the fourth sub-frame SF4 and the seventh sub-frame SF7, instead of being displayed in one sub-frame.

In the above-described exemplary embodiment, although ‘32’ is allocated to two sub-frames, the fourth sub-frame SF4 and the seventh sub-frame SF7, instead of being displayed in one sub-frame, the present invention is not limited to this. So far as the two sub-frames are not consecutive, they are not limited to the fourth sub-frame SF4 and the seventh sub-frame SF7. Since the fourth sub-frame SF4 and the seventh sub-frame SF7 are consecutive to each other in subsequent frame, they are not designated.

Although in the above-described exemplary embodiment the fourth sub-frame SF4 and the seventh sub-frame SF7 have the same period of length, they may have a different length of period to each other. In such case, when the sum of the fourth sub-frame SF4 and the seventh sub-frame SF7, which are different lengths of period from each other, is made to be thirty two times (2ⁿ⁻¹ times) of the shortest period, it is possible to display half tone of sixty four levels (2ⁿ⁺¹ levels) like the above-described exemplary embodiment.

In the above-described exemplary embodiment, ‘32’ is allocated to two sub-frames, however, it is possible to allocate it three or more sub-frames, for example, sub-frames designating ‘8’, ‘8’, and ‘16’.

The above-described exemplary embodiment is described above with respect to the control of half tone of sixty four gray scales. However, the present invention may be applied to the control of other 2ⁿ gray scales such as gray scale of ‘16’, gray scale of ‘32’, gray scale of ‘128’, or gray scale of ‘256’.

In the pixel circuits 20 of the above-described exemplary embodiment, the gate of the reset transistor Q3 and the gate of the switching transistor Q3 are connected to the same scanning line. However, it is possible to provide an exclusive scanning line to provide resetting, and connect the gate of the reset transistor Q3 to the exclusive scanning line to provide resetting.

[Exemplary Advantages]

According to the present invention, it is possible to decrease flicker.

What is claimed is:

1. An electro-optical device, comprising:
a plurality of pixels, each of the plurality of pixels having an electro-optical element, brightness of each of the electro-optical elements being set for each of a plurality of sub-frames, which constitute one frame of a period and each have a predetermined period, so that at least two levels of brightness can be set for one frame, and the plurality of sub-frames including at least two sub-frames having the same period of length.

2. The electro-optical device according to claim 1,
the at least two sub-frames having the longest period among the plurality of sub-frames.

3. The electro-optical device according to claim 2,
a sub-frame having the longest period among the plurality of sub-frames excluding the at least two sub-frames being half as long as the sub-frames having the longest period among the plurality of sub-frames.

4. The electro-optical device according to claim 1,
the at least two sub-frames not being arranged consecutively in one frame of a period.

5. An electro-optical device, comprising:
a plurality of pixels, each of the plurality of pixels having an electro-optical element, brightness of the electro-optical element being set for each of a plurality of sub-frames, which constitute one frame of a period and each have a predetermined period, so that at least two levels of brightness can be set for one frame, and lengths of the plurality of sub-frames excluding two sub-frames having the longest period being set to a period in binary weighted.

6. The electro-optical device according to claim 5,
the two sub-frames having the longest period not being arranged consecutively in one frame of a period.

7. An electro-optical device, comprising:
a plurality of pixels, each of the plurality of pixels having an electro-optical element, brightness of the electro-optical element being set for each of a plurality of sub-frames, which constitute one frame of a period and each have a predetermined period, so that at least two levels of brightness can be set for one frame, and a sub-frame having the longest period among n (n denotes a natural number) sub-frames of the plurality of sub-frames excluding two sub-frames having the longest period being set to 2n−1 times as long as a sub-frame having the shortest period among the n sub-frames and brightness for the one frame can be set to 2n+1 levels.

8. The electro-optical device according to claim 7,
the two sub-frames having the longest period not being arranged consecutively in one frame of a period.

9. An electro-optical device, comprising:
a plurality of pixels, each of the plurality of pixels having an electro-optical element, brightness of the electro-optical element being set for each of a plurality of sub-frames, which constitute one frame of a period and each have a predetermined period, so that at least two levels of brightness can be set for one frame, and the sum of two sub-frames having the longest period among the plurality of sub-frames being set to 2n (n denotes a natural number) times as long as a sub-frame having the shortest period among the n sub-frames and brightness for one frame can be set to 2n+1 levels.

10. The electro-optical device according to claim 9,
the two sub-frames not being arranged consecutively in one frame of a period.

11. An electro-optical device, comprising:
a plurality of pixels, each of the plurality of pixels having an electro-optical element, brightness of the electro-optical element being set for each of a plurality of sub-frames, which constitute one frame of period and each have a predetermined period, so that at least 2n (n denotes a natural number) levels of brightness can be set for one frame, and number of the plurality of sub-frames being n+1 or more.

12. The electro-optical device according to claim 11, a sub-frame having the longest period among the plurality of sub-frames being 2n−1 times as long as a sub-frame having the shortest period.

13. An electro-optical device, which is capable of setting at least two levels of brightness for one frame, the electro-optical device comprising:
electro-optical elements that controlled to take either an ON state or an OFF state based on gray scale data for each of a plurality of sub-frames, which constitute one frame of a period and each have a predetermined period, and at least two of the plurality of sub-frames being controlled to always concurrently take either the ON state or the OFF state.

14. The electro-optical device according to claim 13,
the at least two sub-frames having the same period of length.

15. The electro-optical device according to claim 13,
the at least two sub-frames not being arranged consecutively in one frame of a period.

16. The electro-optical device according to claim 1,
the plurality of sub-frames, which are set for a series of pixels among the plurality of pixels, the series of pixels being connected to one scanning line, starting and ending substantially simultaneously.

17. The electro-optical device according to claim 1,
the plurality of sub-frames, which are set for a series of pixels among the plurality of pixels, the series of pixels being connected to at least two scanning lines, ending substantially simultaneously.

18. The electro-optical device according to claim 16, further comprising pixel circuits, each of the pixel circuits including:
a first transistor put into a conductive state when the scanning line thereof is selected;
a capacitor element holding a data signal supplied through the first transistor;
a second transistor switched to an ON state or an OFF state based on the data signal held in the capacitor element; and
an electronic element to which a driving current is supplied based on the ON state of the second transistor.

19. The electro-optical device according to claim 18, the electronic element being a current-driven element.

20. The electro-optical device according to claim 19, the current-driven element being an EL element.

21. The electro-optical device according to claim 20, the EL element having a light-emitting layer formed of an organic material.

22. A method of driving an electro-optical device that includes a plurality of pixels, each of the plurality of pixels having an electro-optical element, the method comprising:
setting brightness of the electro-optical element for each of a plurality of sub-frames, which constitute one frame of period and each have a predetermined period, so that at least two levels of brightness can be set for one frame, the plurality of sub-frame including at least two sub-frames having the same period of length; and
when the at least two sub-frames are set, arranging the at least two sub-frames so as not to be adjacent to each other.

23. A method of driving an electro-optical device that includes a plurality of pixels, each of the plurality of pixels having an electro-optical element, the method comprising:
setting brightness of the electro-optical elements for each of a plurality of sub-frames, which constitute one frame of period and each have a predetermined period, so that at least two levels of brightness can be set for one frame, lengths of the plurality of sub-frames excluding two sub-frames having the longest period being set in binary load; and
when the two sub-frames are set, arranging the two sub-frames so as not to be adjacent to each other.

24. A method of driving an electro-optical device that includes a plurality of pixels, each of the plurality of pixels having an electro-optical element, the method comprising:
setting brightness of the electro-optical elements for each of a plurality of sub-frames, which constitute one frame of period and each have a predetermined period, so that at least two levels of brightness can be set for one frame, a sub-frame having the longest period among n (n denotes a natural number) sub-frames of the plurality of sub-frames excluding two sub-frames having the longest period being set to 2n−1 times as long as a sub-frame having the shortest period of the n sub-frames; and
when the two sub-frames are set, arranging the two sub-frames so as not to be adjacent to each other, and brightness for one frame being set to 2n+1 levels.

25. A method of driving an electro-optical device that includes a plurality of pixels, each of the plurality of pixels having an electro-optical element, the method comprising:
setting brightness of the electro-optical elements t for each of a plurality of sub-frames, which constitute one frame of period and each have a predetermined period, so that at least two levels of brightness can be set for one frame, the sum of two sub-frames having the longest period among the plurality of sub-frames being set 2n (n denotes a natural number) times as long as a sub-frame having the shortest period among the n sub-frames; and
when the two sub-frames are set, arranging the two sub-frames so as not to be adjacent to each other, and brightness for one frame being set to 2n+1 levels.

26. A method of driving an electro-optical device that includes a plurality of pixels, each of the plurality of pixels having an electro-optical element, the method comprising:
setting brightness of the electro-optical element for each of a plurality of sub-frames, which constitute one frame of period and each have a predetermined period, so that at least 2n (n denotes a natural number) levels of brightness are set for one frame;
always concurrently putting predetermined two sub-frames into a set state or a non-set state, the number of the plurality of sub-frames being n+1 or more; and
when being in the set state, arranging the two sub-frames so as not to be adjacent to each other, and brightness for one frame being settable to 2n levels.

27. The method of driving an electro-optical device according to claim 22,
the plurality of sub-frames, which are set for a series of pixels among the plurality of pixels, the series of pixels being connected to one scanning line, starting and ending substantially simultaneously.

28. The method of driving an electro-optical device according to claim 22,
the plurality of sub-frames, which are set for a series of pixels among the plurality of pixels, the series of pixels being connected to at least two scanning lines, ending substantially simultaneously.

29. The method of driving an electro-optical device according to claim 27, the electro-optical device including pixel circuits, each of the pixel circuits including:
a first transistor put into a conductive state when the scanning line thereof is selected;
a capacitor element holding a data signal supplied through the first transistor;
a second transistor controlled to take an ON state or an OFF state based on the data signal held in the capacitor element; and
an electronic element to which a driving current is supplied based on the ON state of the second transistor.

30. An electronic apparatus, comprising:
the electro-optical device according to claim 1.
